(19) United States
(12) Patent Application Publication
(10) Pub. No.: US 2026/0045252 A1
(43) Pub. Date: Feb. 12, 2026

(54) TRAINING FOR A MULTIMODAL SPEECH LANGUAGE LARGE MODEL

(71) Applicant: BEIJING BAIDU NETCOM SCIENCE TECHNOLOGY CO., LTD., BEIJING (CN)

(72) Inventors: Shuohuan WANG, BEIJING (CN); Junyuan SHANG, BEIJING (CN); Zhenyu ZHANG, BEIJING (CN); Yu SUN, BEIJING (CN); Hua WU, BEIJING (CN)

(73) Assignee: BEIJING BAIDU NETCOM SCIENCE TECHNOLOGY CO., LTD., BEIJING (CN)

(21) Appl. No.: 19/364,177

(22) Filed: Oct. 21, 2025

(30) Foreign Application Priority Data
Jun. 10, 2025 (CN) 202510772945.3

(51) Int. Cl. G10L 15/06; G10L 15/32

(52) U.S. Cl. CPC G10L 15/063; G10L 15/32

(57) ABSTRACT

A training method for a multimodal speech language large model is provided. The implementation is: obtaining first response speech data generated by the multimodal speech language large model by inputting first inquiry speech data into the multimodal speech language large model; determining an inquiry text corresponding to the first inquiry speech data and a response text corresponding to the first response speech data; determining, based on the inquiry text and the response text, a first score; determining, based on speech features of the first inquiry speech data and speech features of the first response speech data, a second score, where the speech features include at least one of speech clarity, speech rate feature, timbre feature, intonation feature, and emotion feature; and adjusting, based on the first score and the second score, parameters of the multimodal speech language large model.

### CROSS REFERENCE TO RELATED APPLICATION

This application claims priority to Chinese Patent Application No. 2025107729453, filed on Jun. 10, 2025, the contents of which are hereby incorporated by reference in their entirety for all purpose.

### TECHNICAL FIELD

The present disclosure relates to the technical field of artificial intelligence, particularly to the technical fields of speech data processing and data generation, and specifically to a training method for a multimodal speech language large model, a speech data generation method, an electronic device, a computer-readable storage medium.

### BACKGROUND

Artificial intelligence is the discipline of studying how computers can simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, big data processing, etc. The artificial intelligence software technologies mainly include computer vision technology, speech recognition technology, natural language processing technology, machine learning/deep learning, big data processing technology, knowledge diagram technology and other major technological directions.

With the development of computer technologies, artificial intelligence-based generative models can be applied to various forms of natural language processing tasks, including processing of natural language text and natural language speech, particularly generation of response content based on inquiry content of a user to achieve interaction with the user.

The methods described in this section are not necessarily methods that have been previously conceived or employed. Unless otherwise indicated, it should not be assumed that any method described in this section is considered to be prior art only due to its inclusion in this section. Similarly, the problems mentioned in this section should not be assumed to be recognized in any prior art unless otherwise indicated

### SUMMARY

The present disclosure provides a computer-implemented training method for a multimodal speech language large model, an electronic device, a computer-readable storage medium.

According to an aspect of the present disclosure, a computer-implemented training method for a multimodal speech language large model is provided, including: obtaining first response speech data generated by the multimodal speech language large model by inputting first inquiry speech data into the multimodal speech language large model; determining an inquiry text corresponding to the first inquiry speech data and a response text corresponding to the first response speech data; determining, based on at least one speech feature of the first inquiry speech data and at least one speech feature of the first response speech data, a second score, wherein the at least one speech feature includes at least one of speech clarity, speech rate feature, timbre feature, intonation feature, and emotion feature; and adjusting, based on the first score and the second score, parameters of the multimodal speech language large model.

According to an aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to perform operations comprising: obtaining first response speech data generated by a multimodal speech language large model by inputting first inquiry speech data into the multimodal speech language large model; determining an inquiry text corresponding to the first inquiry speech data and a response text corresponding to the first response speech data; determining, based on the inquiry text and the response text, a first score; determining, based on at least one speech feature of the first inquiry speech data and at least one speech feature of the first response speech data, a second score, wherein the at least one speech feature includes at least one of speech clarity, speech rate feature, timbre feature, intonation feature, and emotion feature; and adjusting, based on the first score and the second score, parameters of the multimodal speech language large model.

According to an aspect of the present disclosure, a non-transitory computer-readable storage medium storing computer instructions is provided, wherein the computer instructions are used to cause a computer to perform operations comprising: obtaining first response speech data generated by a multimodal speech language large model by inputting first inquiry speech data into the multimodal speech language large model; determining an inquiry text corresponding to the first inquiry speech data and a response text corresponding to the first response speech data; determining, based on the inquiry text and the response text, a first score; determining, based on at least one speech feature of the first inquiry speech data and at least one speech feature of the first response speech data, a second score, wherein the at least one speech feature includes at least one of speech clarity, speech rate feature, timbre feature, intonation feature, and emotion feature; and adjusting, based on the first score and the second score, parameters of the multimodal speech language large model.

According to one or more embodiments of the present disclosure, the quality of speech data generation can be improved, thereby achieving more accurate human-machine speech question-answering interaction.

It should be understood that the content described in this section is not intended to identify key or important features of the embodiments of the present disclosure, nor is it intended to limit the scope of the present disclosure. Other features of the present disclosure will become readily understood from the following description.

### BRIEF DESCRIPTION OF THE DRAWINGS

The drawings illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein may be implemented according to example embodiments of the present disclosure;

FIG. 2 illustrates a flowchart of a training method for a multimodal speech language large model according to an example embodiment of the present disclosure;

FIG. 3 illustrates a structural schematic diagram of a multimodal speech language large model according to an example embodiment of the present disclosure;

FIG. 4 illustrates a structural schematic diagram of a question-answering evaluation model according to an example embodiment of the present disclosure;

FIG. 5 illustrates a schematic diagram of a training process of a multimodal speech language large model according to an example embodiment of the present disclosure;

FIG. 6 illustrates a flowchart of a speech data generation method according to an example embodiment of the present disclosure;

FIG. 7 illustrates a schematic diagram of a speech data generation process according to an example embodiment of the present disclosure;

FIG. 8 illustrates a structural block diagram of a training apparatus for a multimodal speech language large model according to an example embodiment of the present disclosure;

FIG. 9 illustrates a structural block diagram of a speech data generation apparatus according to an example embodiment of the present disclosure;

FIG. 10 illustrates a structural block diagram of an example electronic device that can be used to implement embodiments of the present disclosure.

### DETAILED DESCRIPTION OF THE EMBODIMENTS

The example embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first” , “second” and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms “and/or” used in the present disclosure encompass any one of the listed items and all possible combinations thereof.

Embodiments of the present disclosure will be described in detail below with reference to the accompanying drawings.

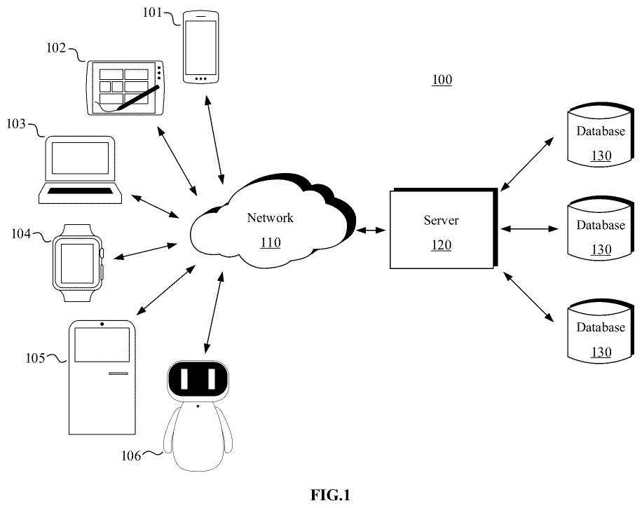

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105 and 106, a server 120, and one or more communication networks 110 that couple one or more client devices to the server 120. The client devices 101, 102, 103, 104, 105, and 106 may be configured to execute one or more applications.

In embodiments of the present disclosure, the server 120 may run one or more services or software applications that enable execution of a training method for a multimodal speech language large model.

In some embodiments, the server 120 may also provide other services or software applications, which may include non-virtual environments and virtual environments. In some embodiments, these services may be provided as web-based services or cloud services, such as to the user of the client devices 101, 102, 103, 104, 105, and/or 106 under a Software as a Service (Saas) model.

In the configuration shown in FIG. 1, the server 120 may include one or more components that implement functions performed by the server 120. These components may include software components, hardware components, or a combination thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to send inquiry speech data. The client devices may provide an interface that enables the user of the client devices to interact with the client devices. The client devices may also output information to the user via the interface. Although FIG. 1 depicts only six client devices, those skilled in the art will be able to understand that the present disclosure may support any number of client devices.

The client devices 101, 102, 103, 104, 105, and/or 106 may include various types of computer devices, such as portable handheld devices, general-purpose computers, such as personal computers and laptop computers, workstation computers, wearable devices, smart screen devices, self-service terminal devices, service robots, gaming systems, thin clients, various messaging devices, sensors, or other sensing devices, and the like. These computer devices may run various types and versions of software applications and operating systems, such as Microsoft Windows, Apple iOS, Unix-like operating systems, Linux or Linux-like operating systems (e.g., Google Chrome OS); or include various mobile operating systems, such as Microsoft Windows Mobile OS, iOS, Windows Phone, Android. The portable handheld devices may include cellular telephones, smart phones, tablet computers, personal digital assistants (PDAs), and the like. The wearable devices may include head-mounted displays, such as smart glasses, and other devices. The gaming systems may include various handheld gaming devices, Internet-enabled gaming devices, and the like. The client devices can perform various different applications, such as various applications related to the Internet, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, WiFi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a Java server, a database server, etc.

In some implementations, the server 120 may include one or more applications to analyze and merge data feeds and/or event updates received from the user of the client devices 101, 102, 103, 104, 105, and 106. The server 130 may also include one or more applications to display the data feeds and/or the real-time events via one or more display devices of the client devices 101, 102, 103, 104, 105, and 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in a cloud computing service system to overcome the defects of management difficulty and weak service expansibility exiting in a traditional physical host and virtual private server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote from the server 120 and may communicate with the server 120 via a network-based or dedicated connection. The databases 130 may be of different types. In some embodiments, the database used by the server 120 may be, for example, a relational database. One or more of these databases may store, update, and retrieve data to and from the database in response to a command.

In some embodiments, one or more of the databases 130 may also be used by an application to store application data. The databases used by the application may be different types of databases, such as a key-value repository, an object repository, or a conventional repository supported by a file system.

The system 100 of FIG. 1 may be configured and operated in various ways to enable application of various methods and apparatuses described according to the present disclosure.

In the related art, when conducting a human-machine conversation with a user using an artificial intelligence-based data generation model, the data generation model is generally a large language model that is capable of processing and generating a natural language text. In this case, when it is necessary to conduct a voice conversation between the user and the computer, response speech data for broadcasting to the user can be generated based on a cascaded system of a speech recognition module—a large language model—a speech synthesis module, that is, it is required to convert inquiry speech data input by the user into an inquiry text using a speech recognition technology, cause the large language model to generate a response text based on the inquiry text, and then generate the response speech data corresponding to the response text using a speech synthesis technology. Although this approach can utilize the cognitive capability of current large language models, a cascading error in the system can effect overall performance of speech question-answering, and the accuracy of the speech response remains insufficient. Additionally, this approach fails to utilize artificial intelligence networks to generate a speech response with diversity in aspects such as speech rate, timbre, and emotion, thereby failing to fully meet the requirements of the user, and there is still room for improvement in the quality of the response speech data.

Based on this, the present disclosure provides a training method for a multimodal speech language large model, which sets, for the response speech data directly generated by the multimodal speech language large model, reward scores from two perspectives of text content perspective and speech feature perspective, such that the accuracy of the response content and the quality of the response speech (e.g., higher clarity, speech emotion matches inquiry data, appropriate speech rate) can be optimized respectively based on the text score and the speech score, and more accurate speech response can be achieved by using the optimized model.

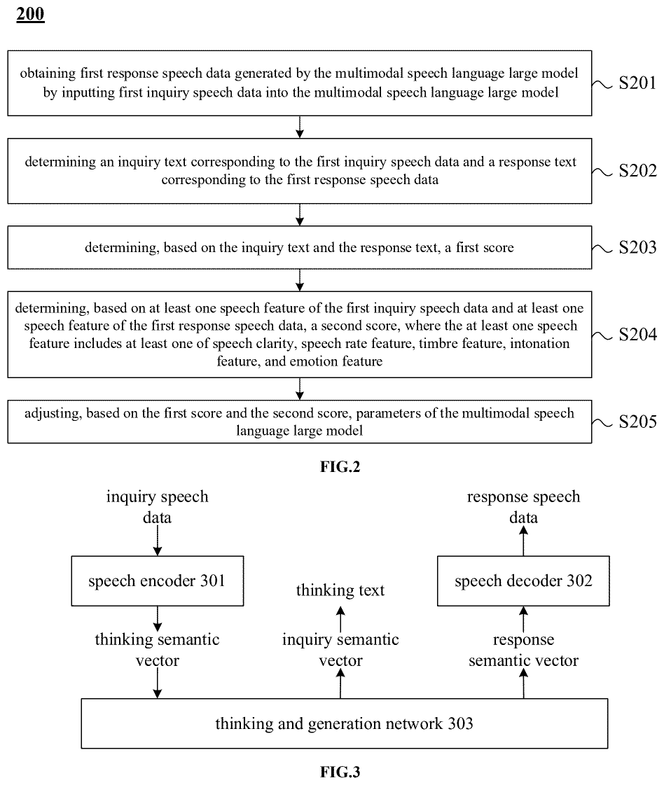

FIG. 2 illustrates a flowchart of a training method 200 for a multimodal speech language large model according to an example embodiment of the present disclosure. As shown in FIG. 2, the method 200 includes:
step S201, obtaining first response speech data generated by the multimodal speech language large model by inputting first inquiry speech data into the multimodal speech language large model;
step S202, determining an inquiry text corresponding to the first inquiry speech data and a response text corresponding to the first response speech data;
step S203, determining, based on the inquiry text and the response text, a first score; step S204, determining, based on at least one speech feature of the first inquiry speech data and at least one speech feature of the first response speech data, a second score, where the at least one speech feature includes at least one of speech clarity, speech rate feature, timbre feature, intonation feature, and emotion feature; and
step S205, adjusting, based on the first score and the second score, parameters of the multimodal speech language large model.

By applying the above method 200, it is possible to set, for the response speech data directly generated by the model during the training process of the multimodal speech language large model, reward scores from two perspectives of text content perspective and speech feature perspective, thereby enabling to optimize the accuracy of the response content and the quality of the response speech more precisely based on the text content score and the speech feature score, for example, the clarity of the response speech can be improved, the speech rate can be more appropriate, or the emotional expression of the response speech can better match that of the inquiry speech, and thereby achieving a more accurate and high-quality speech response using the optimized model.

In some examples, the multimodal speech language large model can be a speech language large model pre-trained using large-scale corpora, and the multimodal speech language large model can perform intelligent understanding and content generation over multiple modalities (e.g., speech and text information). In some examples, the multimodal speech language large model adopts a cross-modal encoder-decoder architecture and an attention mechanism to achieve semantic alignment and joint modeling of multimodal information. By performing optimization training on the pre-trained large model through the application of the above method 200, it is possible to further optimize, on the basis of fully leveraging the semantic understanding and speech generation capabilities of the pre-trained large model, the diversity of speech features of speech data to more effectively obtain a multimodal speech language large model that is capable of expressing rich and accurate speech features, thereby achieving more accurate human-machine speech question-answering.

In some examples, the determining the inquiry text corresponding to the first inquiry speech data and the response text corresponding to the first response speech data in step S202 can be implemented using an automatic speech recognition (ASR) technology, that is, performing a text recognition on the first inquiry speech data and the first response speech data, and determining the inquiry text and the response text based on the text recognition result to evaluate the accuracy of the response content more accurately based on the text content, thereby improving the response quality of the model.

In some examples, in step S203, the inquiry text and the response text are input into a scoring model to obtain a first score output by the scoring model, the first score can be used to indicate whether the fact described in the response text is accurate, and can further indicate whether the content of the response text is consistent with the question intent of the inquiry text. In some examples, the scoring model can be supervised trained using question-answering text pairs annotated with reference scores, and the output result of the scoring model can then be used to evaluate the content quality of the response text. In some examples, the scoring model can be constructed based on a large language model (LLM) trained using large-scale corpora, for example it may be performing fine-tuning training using the above annotated data on the basis of a pre-trained large language model, such that the evaluation model can evaluate the quality of the response content more comprehensively and accurately.

According to some embodiments, in step S204, the determining, based on the speech features of the first inquiry speech data and the speech features of the first response speech data, the second score includes: in response to determining that the first inquiry speech data includes descriptive information for the speech features of the first response speech data, determining the second score based on the descriptive information, the speech features of the first inquiry speech data, and the speech features of the first response speech data. As a result, explicit instructions contained in the inquiry data (e.g., specific requirements for the timbre, intonation and speech rate of the response) can be obtained during the scoring process, such that the optimized model can output response data that better aligns with the inquiry requirements.

According to some embodiments, in step S204, the determining, based on the speech features of the first inquiry speech data and the speech features of the first response speech data, the second score includes: determining, based on the speech features of the first inquiry speech data, identity features of the speaker of the first inquiry speech data; and determining, based on the identity features, the response text, and the speech features of the first response speech data, the second score. As a result, the speech features of the inquiry data can be captured during the scoring process to avoid inconsistency between the response data and the inquiry data. For example, when the inquiry data is from a female voice, the response content should not include any address terms intended for males, thereby improving the accuracy of the response.

According to some embodiments, in step S204, the determining, based on the speech features of the first inquiry speech data and the speech features of the first response speech data, the second score includes: determining the second score output by the question-answering evaluation model by inputting the first inquiry speech data and the first response speech data into a question-answering evaluation model, where the question-answering evaluation model is trained using first sample inquiry speech data, first sample response speech data, and a reference score. The efficiency and accuracy of scoring can be improved by training the question-answering evaluation model using annotated data and then outputting the reward score for the speech features of the speech data using the question-answering evaluation model during the training process of the multimodal speech language large model.

In some examples, the question-answering evaluation model can be trained using a plurality of question-answering speech data pairs annotated with reference scores, and to improve the accuracy of the question-answering evaluation model in evaluating the speech features of the response speech data, question-answering speech data pairs with the same text content but different speech features can be included in the training data. For example, the training data can simultaneously include: speech data 1 corresponding to content A and timbre B, speech data 2 corresponding to content A and timbre C, for another example, the training data can further simultaneously include: speech data 3 corresponding to content A and emotion D, and speech data 4 corresponding to content A and emotion E. By configuring question-answering speech data pairs in the training data with identical text content but different speech features, the impact of the differences in text content on speech data features can be eliminated, enabling the evaluation model to learn different speech features (e.g., speech clarity, speech rate feature, timbre feature, intonation feature, and emotion feature) more precisely, thereby evaluating the quality of speech data with different speech features more accurately.

In some examples, in steps S203 and S204, the first score and the second score can also be determined based on other approaches, for example, the scoring can be based on a predefined scoring rule. In this example, the predefined scoring rule can include a plurality of dimensions, such as content conciseness, speech clarity, whether the speech data expresses active and positive emotions, and the like. By predefining a scoring rule and guiding the optimization training of the multimodal speech language large model based on the predefined scoring rule, it is enabled that the output result of the multimodal speech language large model can better align with the requirements of actual application scenarios, thereby achieving higher-quality human-machine speech question-answering.

According to some embodiments, in step S205, the adjusting, based on the first score and the second score, the parameters of the multimodal speech language large model includes: determining, based on the first score and the second score, reward information; and adjusting, based on the reinforcement learning strategy corresponding to the reward information, the parameters of the multimodal speech language large model. As a result, a reinforcement learning training can be performed based on the scoring information to obtain a multimodal speech language large model with improved performance.

In some examples, in step S205, it may be performing fine-tuning on the model using the RLHF (Reinforcement Learning with Human Feedback) method, that is, the parameters of the model can be adjusted based on various types of reinforcement learning strategies, such as proximal policy optimization strategy, population policy relative optimization strategy, direct preference optimization strategy, etc. By adjusting the parameters of the multimodal speech language large model by applying the scoring reward information and a strategy optimization algorithm, it is enabled that the output result of the multimodal speech language large model is as close as possible to the result expected by the scoring reward information, that is, higher-quality response speech data is obtained, and the accuracy of human-machine speech interaction is improved.

According to some embodiments, method 200 further includes: obtaining second response speech data generated by the multimodal speech language large model by inputting second inquiry speech data into the multimodal speech language large model; obtaining reference response speech data corresponding to the second inquiry speech data; and adjusting, based on the second response speech data and the reference response speech data, the parameters of the multimodal speech language large model. Thereby, the quality of response speech data output by the model can be further improved, on the basis of reward score-based training, by combining the model optimization method that performs supervised training using annotated data.

In some examples, the first inquiry speech data and the second inquiry speech data can be the same, that is, after inputting the inquiry speech data into the multimodal speech language large model, the quality scoring for the response speech data generated by the model is performed, and simultaneously the loss value can also be calculated based on the response speech data generated by the model and the reference response speech data corresponding to the inquiry speech data, or the quality scoring result can be effected based on the difference between the model output result and the reference result to perform fine-tuning training on the model by combining the reference annotation information and the quality scoring information of the sample data. In some examples, the first inquiry speech data and the second inquiry speech data may be different, that is, different training methods are applied to the multimodal speech language large model. In one example, the training process of the multimodal speech language large model includes the following two stages: in the first stage, it can be performing supervised fine-tuning (SFT) on the basis of a pre-trained speech language large model, that is, inputting the sample inquiry speech data annotated with the reference response speech data into the pre-trained model, and calculating the loss value based on the result output by the model and the annotation content, and then adjusting the parameters of the model based on the loss value, that is, this stage corresponds to the technical approach described above, which performs training using the second inquiry speech data and the reference response speech data corresponding to the second inquiry speech data. The training in this phase may be, for example, performing autoregressive learning with a maximum likelihood objective to improve the training efficiency and effectiveness. In the second stage, it can be inputting the unannotated first inquiry speech data into the multimodal speech language large model, and then performing content quality scoring and audio quality scoring on the output result of the model and performing reinforcement learning training based on the reward scores from two to more precisely optimize the accuracy of the response content and the ability of the model to represent diverse speech features, thereby improving the performance of the model.

According to some embodiments, the multimodal speech language large model generates the second response speech data using the following manner: generating predicted thinking information based on the second inquiry speech data, where the predicted thinking information includes descriptive information for the speech features of the second response speech data; and generating the second response speech data based on the predicted thinking information, and where the method 200 further includes: obtaining reference thinking information corresponding to the second inquiry speech data; and adjusting the parameters of the multimodal speech language large model based on the predicted thinking information and the reference thinking information. As a result, it is enabled that chain of thought-based thinking process can be incorporated in the response data generation process, that is, enabling the large model to decompose a generation task, output based on a logical chain of think-then-generate, and indicate speech features to be output utilizing the thinking information, such that the generated response speech data is more accurate.

In some examples, the reasoning mechanism of the multimodal speech language large model is constructed based on Chain-of-Thought (CoT) technology, that is, enabling the model to simulate the cognitive pattern of “step-by-step thinking and sequential reasoning” of a human being, first output the thinking information after receiving the input inquiry speech data, and then further generate the response speech data. By first making the model consider the speech features of the response speech data to be generated, the quality of the speech data generated by the model can be improved. In this example, the sample data in the model training process is annotated with reference thinking information, that is, the thinking process of the model can be precisely optimized based on the reference thinking information and the predicted thinking information output by the model, thereby further improving the accuracy of model reasoning and enhancing the quality of the generated data.

According to some embodiments, the reference thinking information is text information, and the generating the predicted thinking information based on the second inquiry speech data includes: encoding the second inquiry speech data into an inquiry semantic vector in a semantic vector space; generating, based on the inquiry semantic vector, a thinking semantic vector in the semantic vector space; and where the generating, based on the predicted thinking information, the second response speech data includes: generating, based on the thinking semantic vector, a response semantic vector in the semantic vector space; and decoding the response semantic vector into the second response speech data, and where the adjusting, based on the predicted thinking information and the reference thinking information, the parameters of the multimodal speech language large model includes: decoding the thinking semantic vector into a predicted thinking text; and adjusting, based on the predicted thinking text and the reference thinking information, the parameters of the multimodal speech language large model. Thereby, the thinking information of the model can be annotated more conveniently and accurately by using the text information to improve the accuracy of the thinking of the model. In this case, the question-thinking-response chain that performs speech question-answering using the model includes speech modality data and text modality data. By converting the speech modality data and the text modality data into the same semantic vector space, a multimodal unified intelligent content understanding is achieved, the cascading loss caused by modality conversion is avoided, the performance of the model is optimized, and the accuracy of data generation is improved.

In some examples, the operation of encoding the speech modality data and the text modality data into semantic vectors in the semantic vector space is based on a tokenizer technology. Specifically, the tokenizer can split the original speech modality data and text modality data into discrete text tokens and audio tokens, and then map them into digital sequences that can be processed by a computer, that is, encoded them into semantic vectors. In this example, the mapping table of text tokens and the mapping table of audio tokens are concatenated to form an overall table space of the multimodal speech language large model, that is, the mapping of multimodal information to the same semantic vector space is achieved, such that the model can understand and process the multimodal information, thereby improving the quality of data generation.

According to some embodiments, the reference response speech data is annotated with speech breakpoints, the second response speech data consists of a first speech segment and a second speech segment, and adjusting, based on the second response speech data and the reference response speech data, the parameters of the multimodal speech language large mode includes: splitting, based on the speech breakpoints, the reference response speech data into a first reference segment and a second reference segment; adjusting, based on the first speech segment and the first reference segment, the parameters of the multimodal speech language large model; and adjusting, based on the second speech segment and the second reference segment, the parameters of the multimodal speech language large model. In some examples, the multimodal speech language large model is configured to perform staged output during the data generation process, once part of the response speech has been generated, the generated part of the response speech is first output to the user, and continuing to generate the remaining part of the response speech while outputting the broadcasting. In this case, the multimodal speech language large model can broadcast the speech response to the user more quickly during human-machine speech question-answering process, thereby reducing user waiting time. By performing fine-tuning on the model utilizing training data annotated with speech breakpoints, the model can learn the timing for splitting the response speech data, and then during the data generation process, the model can determine the timing for first outputting part of the response speech and output the response speech data in the form of a sequence of speech segments, without waiting for all response data to be generated before performing speech broadcasting, thereby improving the response fluency of the model during human-machine speech interaction and enhancing the user experience.

FIG. 3 illustrates a structural diagram of a multimodal speech language large model according to an example embodiment of the present disclosure. As shown in FIG. 3, the multimodal speech language large model includes a speech encoder 301, a speech decoder 302, and a thinking and generation network 303. In this example, the speech encoder 301 is configured to encode inquiry speech data into an inquiry semantic vector so that the thinking and generation network 303 can perform thinking and responding based on the inquiry semantic vector, and then sequentially output a thinking semantic vector and a response semantic vector. In one example, the thinking and generation network 303 first determines the thinking semantic vector based on the inquiry semantic vector, indicates the content and speech features to be generated based on the thinking content, and then performs further thinking and generation based on the inquiry semantic vector and the thinking semantic vector to obtain a final response semantic vector. In an example, the thinking semantic vector can be decoded into a thinking text and be output to display explicit thinking information to the user, who can then provide feedback to the model based on his/her needs after reviewing the thinking information. The speech decoder 302 is configured to decode the response semantic vector into response speech data and output it. In this example, the inquiry semantic vector, the thinking semantic vector, and the response semantic vector are in the same semantic vector space, and by mapping multimodal information to this semantic vector space, the thinking and generation network 303 can perform unified intelligent understanding and processing on the multimodal information to improve the accuracy of data generation.

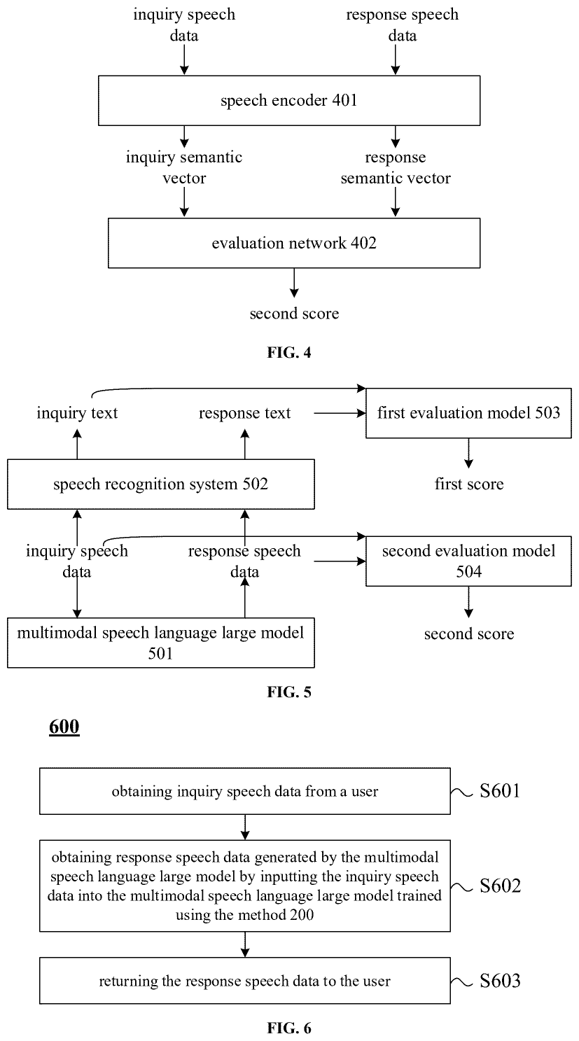

FIG. 4 illustrates a structural diagram of the question-answering evaluation model according to an example embodiment of the present disclosure. As shown in FIG. 4, the question-answering evaluation model includes a speech encoder 401 and an evaluation network 402. The speech encoder 401 is configured to encode inquiry speech data and response speech data to be evaluated into a inquiry semantic vector and a response semantic vector, such that the evaluation network 402 can obtain a second score based on the inquiry semantic vector and the response semantic vector. In some examples, the speech encoder 401 in the question-answering evaluation model may be the same unit as the speech encoder 301 in the thinking and generation network 303 described above, that is, the thinking and generation network 303 described above and the evaluation network 402 in the question-answering evaluation model may perform intelligent understanding and information processing based on the same semantic vector space.

FIG. 5 illustrates a schematic diagram of a training process for a multimodal speech language large model according to an example embodiment of the present disclosure. As shown in FIG. 5, after inputting inquiry speech data into the multimodal speech language large model 501 and obtaining response speech data, the speech recognition system 502 is used to determine an inquiry text corresponding to the inquiry speech data and a response text corresponding to the response speech data, and then the first evaluation model 503 is used to output a first score, which can indicate whether the response content for the inquiry content is accurate and comprehensive, based on the inquiry text and the response text. The second evaluation model 504 is configured to output, based on the inquiry speech data and the response speech data, a second score for speech features to indicate whether the response speech data is clear or whether its speech rate, timbre, and emotion meet the requirements of the inquiry data. By fine-tuning the multimodal speech language large model 503 based on the first score and the second score, the content accuracy and speech expression richness of the response output by the model can be precisely optimized, and then the accuracy of human-machine speech question-answering can be improved by using the trained model.

In an example, the multimodal speech language large model 503 is fine-tuned using annotated sample data prior to the foregoing training phase. Both the reference speech response data and the reference thinking information can be annotated in annotated sample data, and the annotated information can be used to specifically optimize the thinking process and data generation process of the model to improve the training efficiency and optimize the model performance.

In an example, the multimodal speech language large model 503 outputs the response speech data in the form of a sequence of speech segments. In this case, after the multimodal speech language large model 503 has output all the response speech segments, all the segments can be concatenated into complete response speech data, which can then be converted into response text and scored. When the annotated sample data is annotated with speech breakpoints of the reference speech response data, it can indicate whether the splitting timing of the response speech segments output by the model is accurate based on the speech breakpoint information, and the model can learn the accurate splitting timing of the speech response by being fine-tuned based on the annotated information, thereby improving the fluency of the speech response.

According to an aspect of the present disclosure, a speech data generation method is provided. FIG. 6 illustrates a flowchart of a speech data generation method 600 according to an example embodiment of the present disclosure. As shown in FIG. 6, the method 600 includes:
step S601: obtaining inquiry speech data from a user;
step S602: obtaining response speech data generated by the multimodal speech language large model by inputting the inquiry speech data into the multimodal speech language large model trained using the method 200; and
step S603: returning the response speech data to the user.

By applying the above multimodal speech language large model to conduct human-machine speech question-answering, response speech data with richer and more accurate speech features such as timbre, emotion, speech rate and the like can be returned, making the response content better meets user requirements and improving the user experience.

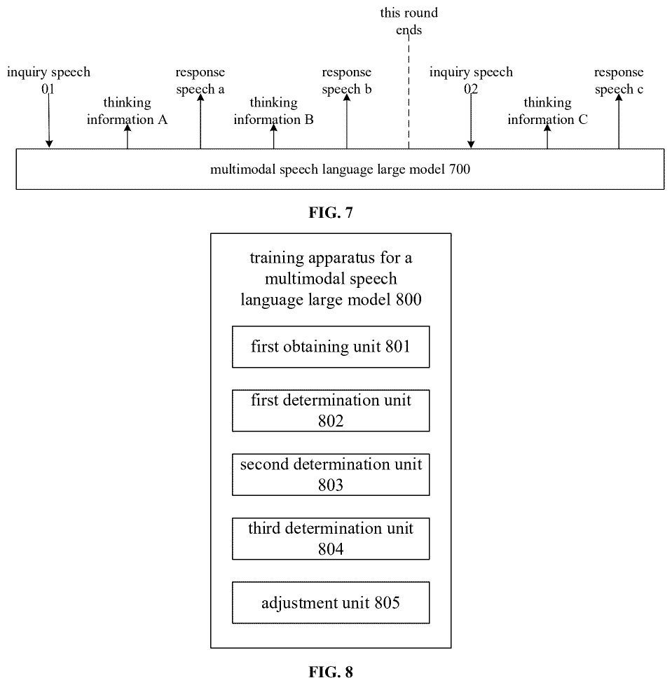

FIG. 7 illustrates a schematic diagram of a speech data generation process according to an example embodiment of the present disclosure. As shown in FIG. 7, after receiving the inquiry speech 01, the multimodal speech language large model 700 can first perform thinking and output staged thinking information A, and then output response speech obtained based on the thinking information A, and while the response speech a is being played, the model can continue to perform thinking and output the thinking information B of the next stage, and then output the response speech b obtained based on the thinking information B. When the model determines that it has output all the response content for the inquiry speech 01, the end of the response speech b can have a symbol information, indicating the end of the response, to indicate the end of the question-answer round for the inquiry speech 01. After the previous round ends, the user can continue to input the inquiry speech 02, and the multimodal speech language large model 700 can perform thinking and data generation based on the new inquiry speech 02 to output the thinking information C and the response speech c. By having the model output response speech data in the form of a sequence of speech segments during the data generation process, serialized speech output can be achieved during voice interaction without waiting for all response data to be generated before performing speech broadcasting, thereby reducing the waiting time of the user, improving the fluency of the voice response, and improving the user experience.

According to an aspect of the present disclosure, a training apparatus for a multimodal speech language large model is provided. FIG. 8 illustrates a structural block diagram of a training apparatus 800 for a multimodal speech language large model according to an example embodiment of the present disclosure. As shown in FIG. 8, the apparatus 800 includes:
a first obtaining unit 801 configured to obtain first response speech data generated by the multimodal speech language large model by inputting first inquiry speech data into the multimodal speech language large model;
a first determination unit 802 configured to determine an inquiry text corresponding to the first inquiry speech data and a response text corresponding to the first response speech data;
a second determination unit 803 configured to determine, based on the inquiry text and the response text, a first score;
a third determination unit 804 configured to determine, based on speech features of the first inquiry speech data and speech features of the first response speech data, a second score, where the speech features include at least one of speech clarity, speech rate feature, timbre feature, intonation feature, and emotion feature; and
an adjustment unit 805 configured to adjust, based on the first score and the second score, parameters of the multimodal speech language large model.

According to some embodiments, the third determination unit 804 is configured to: determine, in response to determining that the first inquiry speech data includes descriptive information for the speech features of the first response speech data, the second score based on the descriptive information, the speech features of the first inquiry speech data and the speech features of the first response speech data.

According to some embodiments, the third determination unit 804 includes: a first determination sub-unit configured to determine identity features of the speaker of the first inquiry speech data based on the speech features of the first inquiry speech data; and a second determination sub-unit configured to determine the second score based on the identity features, the response text, and the speech features of the first response speech data.

In some embodiments, the third determination unit 804 is configured to: determine, by inputting the first inquiry speech data and the first response speech data into a question-answering evaluation model, the second score output by the question-answering evaluation model, where the question-answering evaluation model is trained using first sample inquiry speech data, first sample response speech data, and a reference score.

According to some embodiments, the adjustment unit 805 includes: a third determination sub-unit configured to determine reward information based on the first score and the second score; and a first adjustment sub-unit configured to adjust the parameters of the multimodal speech language large model based on the reinforcement learning strategy corresponding to the reward information.

According to some embodiments, the first obtaining unit 801 is further configured to obtain second response speech data generated by the multimodal speech language large model by inputting second inquiry speech data into the multimodal speech language large model, and the apparatus 800 further includes: a fourth obtaining unit configured to obtain reference response speech data corresponding to the second inquiry speech data, and where the adjustment unit 805 is further configured to adjust the parameters of the multimodal speech language large model based on the second response speech data and the reference response speech data.

According to some embodiments, the multimodal speech language large model is configured to: generate predicted thinking information based on the second inquiry speech data, where the predicted thinking information includes descriptive information for speech features of the second response speech data; and generate the second response speech data based on the predicted thinking information, and where the apparatus 800 further includes: a fifth obtaining unit configured to obtain reference thinking information corresponding to the second inquiry speech data, and the adjustment unit 805 is configured to adjust the parameters of the multimodal speech language large model based on the predicted thinking information and the reference thinking information.

According to some embodiments, the reference thinking information is text information, and the multimodal speech language large model is configured to: encode the second inquiry speech data into a inquiry semantic vector in a semantic vector space; generate a thinking semantic vector in the semantic vector space based on the inquiry semantic vector; generate a response semantic vector in the semantic vector space based on the thinking semantic vector; and decode the response semantic vector into the second response speech data, and where the adjustment unit 805 includes: a decoding sub-unit configured to decode the thinking semantic vector into a predicted thinking text; and a second adjustment sub-unit configured to adjust the parameters of the multimodal speech language large model based on the predicted thinking text and the reference thinking information.

According to some embodiments, the reference response speech data is annotated with speech breakpoints, the second response speech data consists of a first speech segment and a second speech segment, and the adjustment unit 805 includes: a splitting sub-unit configured to split the reference response speech data into a first reference segment and a second reference segment based on the speech breakpoints; and a third adjustment sub-unit configured to adjust the parameters of the multimodal speech language large model based on the first speech segment and the first reference segment; and adjusting the parameters of the multimodal speech language large model based on the second speech segment and the second reference segment.

According to an aspect of the present disclosure, a speech data generation apparatus is provided. FIG. 9 illustrates a structural block diagram of a speech data generation apparatus 900 according to an example embodiment of the present disclosure. As shown in FIG. 9, the apparatus 900 includes:
a multimodal speech language large model 901 trained using the training apparatus of the multimodal speech language large model as described above;
a second obtaining unit 902 configured to obtain inquiry speech data from a user;
a third acquisition unit 903 configured to obtain response speech data generated by the multimodal speech language large model by inputting the inquiry speech data into the multimodal speech language large model; and
a return unit 904 configured to return the response speech data to the user.

In the technical solution of the present disclosure, the collection, storage, use, processing, transmission, provision, and disclosure of user's personal information are all in compliance with relevant laws and regulations and do not violate public order and good morals.

According to an aspect of the present disclosure, an electronic device is also provided, including: at least one processor; and a memory communicatively connected to the at least one processor; where the memory stores instructions executable by the at least one processor, and the instructions are executed by the at least one processor to enable the at least one processor to perform at least one of the training method for the multimodal speech language large model and the speech data generation method.

According to an aspect of the present disclosure, a non-transitory computer-readable storage medium storing computer instructions is also provided, where the computer instructions are used to cause the computer to perform at least one of the training method for the multimodal speech language large model and the speech data generation method.

According to an aspect of the present disclosure, a computer program product is also provided, including a computer program, where the computer program, when executed by a processor, is capable of implementing at least one of the training method for the multimodal speech language large model and the speech data generation method.

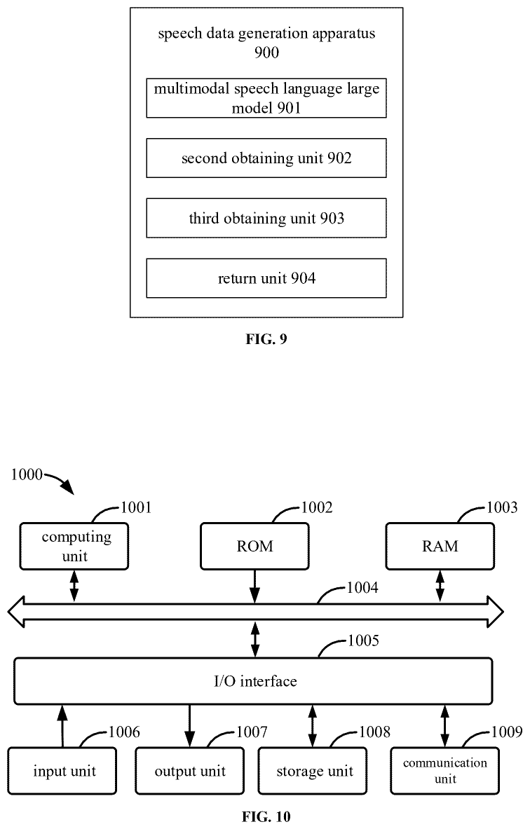

Referring to FIG. 10, a structural block diagram of an electronic device 1000 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 10, the electronic device 1000 includes a computing unit 1001, which may perform various appropriate actions and processing according to a computer program stored in a read-only memory (ROM) 1002 or a computer program loaded into a random access memory (RAM) 1003 from a storage unit 1008. In the RAM 1003, various programs and data required by the operation of the electronic device 1000 may also be stored. The computing unit 1001, the ROM 1002, and the RAM 1003 are connected to each other through a bus 1004. Input/output (I/O) interface 1005 is also connected to the bus 1004.

A plurality of components in the electronic device 1000 are connected to a I/O interface 1005, including: an input unit 1006, an output unit 1007, a storage unit 1008, and a communication unit 1009. The input unit 1006 may be any type of device capable of inputting information to the electronic device 1000, the input unit 1006 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 1007 may be any type of device capable of presenting information, and may include, but are not limited to, a display, a speaker, a video/audio output terminal, a vibrator, and/or a printer. The storage unit 1008 may include, but is not limited to, a magnetic disk and an optical disk. The communication unit 1009 allows the electronic device 1000 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth™ device, a 802.11 device, a WiFi device, a WiMAX device, a cellular communication device, and/or the like.

The computing unit 1001 may be a variety of general and/or special purpose processing components with processing and computing capabilities. Some examples of the computing unit 1001 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, etc. The computing unit 1001 performs the various methods and processes described above, such as the training method for the multimodal speech language large model and the speech data generation method. For example, in some embodiments, the training method for the multimodal speech language large model and the speech data generation method may be implemented as a computer software program tangibly contained in a machine-readable medium, such as the storage unit 1008. In some embodiments, part or all of the computer program may be loaded and/or installed onto the electronic device 1000 via the ROM 1002 and/or the communication unit 1009. When the computer program is loaded to the RAM 1003 and executed by the computing unit 1001, one or more steps of the training method for the multimodal speech language large model and the speech data generation method described above may be performed. Alternatively, in other embodiments, the computing unit 1001 may be configured to perform the training method for the multimodal speech language large model and the speech data generation method by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component(e.g., as a data server), or a computing system including a middleware component (e.g., an application server), or a computing system including a front-end component (e.g., a user computer with a graphic user interface or a web browser, the user may interact with implementations of the systems and techniques described herein through the graphic user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of the technology, many elements described herein may be replaced by equivalent elements appearing after the present disclosure.

1. A computer-implemented training method for a multimodal speech language large model, comprising:
obtaining first response speech data generated by the multimodal speech language large model by inputting first inquiry speech data into the multimodal speech language large model;
determining an inquiry text corresponding to the first inquiry speech data and a response text corresponding to the first response speech data;
determining, based on the inquiry text and the response text, a first score;
determining, based on at least one speech feature of the first inquiry speech data and at least one speech feature of the first response speech data, a second score, wherein the at least one speech feature includes at least one of speech clarity, speech rate feature, timbre feature, intonation feature, and emotion feature; and
adjusting, based on the first score and the second score, parameters of the multimodal speech language large model.

2. The method according to claim 1, wherein the determining, based on the speech features of the first inquiry speech data and the speech features of the first response speech data, the second score comprises:
determining, in response to determining that the first inquiry speech data includes descriptive information for the speech features of the first response speech data, the second score based on the descriptive information, the speech features of the first inquiry speech data, and the speech features of the first response speech data.

3. The method according to claim 1, wherein the determining, based on the speech features of the first inquiry speech data and the speech features of the first response speech data, the second score comprises:
determining, based on the speech features of the first inquiry speech data, identity features of a speaker of the first inquiry speech data; and
determining, based on the identity features, the response text, and the speech features of the first response speech data, the second score.

4. The method according to claim 1, wherein the determining, based on the speech features of the first inquiry speech data and the speech features of the first response speech data, the second score comprises:
determining the second score output by the question-answering evaluation model by inputting the first inquiry speech data and the first response speech data into a question-answering evaluation model, wherein the question-answering evaluation model is trained using first sample inquiry speech data, first sample response speech data, and a reference score.

5. The method according to claim 1, wherein the adjusting, based on the first score and the second score, the parameters of the multimodal speech language large model comprises:
determining, based on the first score and the second score, reward information; and
adjusting, based on a reinforcement learning strategy corresponding to the reward information, the parameters of the multimodal speech language large model.

6. The method according to claim 1, further comprising:
obtaining second response speech data generated by the multimodal speech language large model by inputting second inquiry speech data into the multimodal speech language large model;
obtaining reference response speech data corresponding to the second inquiry speech data; and
adjusting, based on the second response speech data and the reference response speech data, the parameters of the multimodal speech language large model.

7. The method according to claim 6, wherein the multimodal speech language large model generates the second response speech data using following actions:
generating, based on the second inquiry speech data, predicted thinking information, wherein the predicted thinking information includes descriptive information for speech features of the second response speech data; and
generating, based on the predicted thinking information, the second response speech data, and wherein the method further comprises:
obtaining reference thinking information corresponding to the second inquiry speech data; and
adjusting, based on the predicted thinking information and the reference thinking information, the parameters of the multimodal speech language large model.

8. The method according to claim 7, wherein the reference thinking information is text information, and wherein the generating, based on the second inquiry speech data, the predicted thinking information comprises:
encoding the second inquiry speech data into an inquiry semantic vector in a semantic vector space; and
generating, based on the inquiry semantic vector, a thinking semantic vector in the semantic vector space,
and wherein the generating, based on the predicted thinking information, the second response speech data comprises:
generating, based on the thinking semantic vector, a response semantic vector in the semantic vector space; and
decoding the response semantic vector into the second response speech data,
and wherein the adjusting, based on the predicted thinking information and the reference thinking information, the parameters of the multimodal speech language large model comprises:
decoding the thinking semantic vector into a predicted thinking text; and
adjusting, based on the predicted thinking text and the reference thinking information, the parameters of the multimodal speech language large model.

9. The method according to claim 6, wherein the reference response speech data is annotated with a speech breakpoint, and wherein the second response speech data consists of a first speech segment and a second speech segment,
and wherein the adjusting, based on the second response speech data and the reference response speech data, the parameters of the multimodal speech language large model comprises:
splitting, based on the speech breakpoint, the reference response speech data into a first reference segment and a second reference segment;
adjusting, based on the first speech segment and the first reference segment, the parameters of the multimodal speech language large model; and
adjusting, based on the second speech segment and the second reference segment, the parameters of the multimodal speech language large model.

10. The method according to claim 1, further comprising:
obtaining inquiry speech data from a user;
obtaining response speech data generated by the multimodal speech language large model by inputting the inquiry speech data into the multimodal speech language large model; and
returning the response speech data to the user.

11. An electronic device, comprising:
at least one processor; and
a memory communicatively connected to the at least one processor, wherein
the memory stores instructions executable by the at least one processor, and the instructions, when executed by the at least one processor, cause the at least one processor to perform operations comprising:
obtaining first response speech data generated by a multimodal speech language large model by inputting first inquiry speech data into the multimodal speech language large model;
determining an inquiry text corresponding to the first inquiry speech data and a response text corresponding to the first response speech data;
determining, based on the inquiry text and the response text, a first score;
determining, based on at least one speech feature of the first inquiry speech data and at least one speech feature of the first response speech data, a second score, wherein the at least one speech feature includes at least one of speech clarity, speech rate feature, timbre feature, intonation feature, and emotion feature; and
adjusting, based on the first score and the second score, parameters of the multimodal speech language large model.

12. The electronic device according to claim 11, wherein the determining, based on the speech features of the first inquiry speech data and the speech features of the first response speech data, the second score comprises:
determining, in response to determining that the first inquiry speech data includes descriptive information for the speech features of the first response speech data, the second score based on the descriptive information, the speech features of the first inquiry speech data, and the speech features of the first response speech data.

13. The electronic device according to claim 11, wherein the determining, based on the speech features of the first inquiry speech data and the speech features of the first response speech data, the second score comprises:
determining, based on the speech features of the first inquiry speech data, identity features of a speaker of the first inquiry speech data; and
determining, based on the identity features, the response text, and the speech features of the first response speech data, the second score.

14. The electronic device according to claim 11, wherein the determining, based on the speech features of the first inquiry speech data and the speech features of the first response speech data, the second score comprises:
determining the second score output by the question-answering evaluation model by inputting the first inquiry speech data and the first response speech data into a question-answering evaluation model, wherein the question-answering evaluation model is trained using first sample inquiry speech data, first sample response speech data, and a reference score.

15. The electronic device according to claim 11, wherein the adjusting, based on the first score and the second score, the parameters of the multimodal speech language large model comprises:
determining, based on the first score and the second score, reward information; and
adjusting, based on a reinforcement learning strategy corresponding to the reward information, the parameters of the multimodal speech language large model.

16. The electronic device according to claim 11, further comprising:
obtaining second response speech data generated by the multimodal speech language large model by inputting second inquiry speech data into the multimodal speech language large model;
obtaining reference response speech data corresponding to the second inquiry speech data; and
adjusting, based on the second response speech data and the reference response speech data, the parameters of the multimodal speech language large model.

17. The electronic device according to claim 16, wherein the multimodal speech language large model generates the second response speech data using following actions:
generating, based on the second inquiry speech data, predicted thinking information, wherein the predicted thinking information includes descriptive information for speech features of the second response speech data; and
generating, based on the predicted thinking information, the second response speech data,
and wherein the method further comprises:
obtaining reference thinking information corresponding to the second inquiry speech data; and
adjusting, based on the predicted thinking information and the reference thinking information, the parameters of the multimodal speech language large model.

18. The electronic device according to claim 17, wherein the reference thinking information is text information, and wherein the generating, based on the second inquiry speech data, the predicted thinking information comprises:
encoding the second inquiry speech data into an inquiry semantic vector in a semantic vector space; and
generating, based on the inquiry semantic vector, a thinking semantic vector in the semantic vector space,
and wherein the generating, based on the predicted thinking information, the second response speech data comprises:
generating, based on the thinking semantic vector, a response semantic vector in the semantic vector space; and
decoding the response semantic vector into the second response speech data,
and wherein the adjusting, based on the predicted thinking information and the reference thinking information, the parameters of the multimodal speech language large model comprises:
decoding the thinking semantic vector into a predicted thinking text; and
adjusting, based on the predicted thinking text and the reference thinking information, the parameters of the multimodal speech language large model.

19. The electronic device according to claim 16, wherein the reference response speech data is annotated with a speech breakpoint, and wherein the second response speech data consists of a first speech segment and a second speech segment,
and wherein the adjusting, based on the second response speech data and the reference response speech data, the parameters of the multimodal speech language large model comprises:
splitting, based on the speech breakpoint, the reference response speech data into a first reference segment and a second reference segment;
adjusting, based on the first speech segment and the first reference segment, the parameters of the multimodal speech language large model; and
adjusting, based on the second speech segment and the second reference segment, the parameters of the multimodal speech language large model.

20. A non-transitory computer-readable storage medium storing computer instructions, wherein the computer instructions are used to cause a computer to perform operations comprising:
obtaining first response speech data generated by a multimodal speech language large model by inputting first inquiry speech data into the multimodal speech language large model;
determining an inquiry text corresponding to the first inquiry speech data and a response text corresponding to the first response speech data;
determining, based on the inquiry text and the response text, a first score;
determining, based on at least one speech feature of the first inquiry speech data and at least one speech feature of the first response speech data, a second score, wherein the at least one speech feature includes at least one of speech clarity, speech rate feature, timbre feature, intonation feature, and emotion feature; and
adjusting, based on the first score and the second score, parameters of the multimodal speech language large model.
